(19) United States
(12) Patent Application Publication
(10) Pub. No.: US 2009/0031965 A1
(43) Pub. Date: Feb. 5, 2009

(54) Apparatus for the Passive Application of Liquid Pesticides to Cattle

(76) Inventor: Kenneth Lee Campbell, McAlpin, FL (US)

Correspondence Address: Kenneth Lee Campbell, 15864-129th Road, McAlpin, FL, 32062, US

(21) Appl. No.: 11/774,576

(22) Filed: Jul. 7, 2007

(51) Int. Cl. A01K 13/00

(52) U.S. Cl. 119/652

(57) ABSTRACT

A device is described for the passive application of liquid pesticides to cattle, utilizing a heavy structural steel channel for strength and simplicity as the main body and reservoir of the unit, mounted horizontally with a length of heavy structural steel angle welded and braced in a perpendicular manner to each end as mounting brackets. Ropes are fitted through a series of linearly aligned holes with each length of rope being looped through each pair of holes and held securely in position by the use a crimped metal sleeve. Liquid pesticide is poured into the channel to be absorbed by the ropes and the liquid is transferred to the coat of livestock as contact is made with the ropes.

### TECHNICAL FIELD

The present invention relates to materials and methods for applying a treatment to animals and in particular, to an insecticide applicator for animals or a cattle oiler.

### REFERENCES TO U.S. PATENT DOCUMENTS

| | | |
|---|---|---|
| 1,129,977 | Hagny | Mar. 2, 1915 |
| 1,184,438 | Gamble, et al. | May 23, 1916 |
| 2,581,028 | Kirk | Jan. 1, 1952 |
| 2,998,803 | Worden | Sep. 5, 1961 |
| 3,116,717 | Ragsdale | Jan. 7, 1964 |
| 3,159,144 | Duncan, et al. | Dec. 1, 1964 |
| 4,324,202 | Stonestreet, et al. | Apr. 13, 1982 |
| 4,748,939 | Cocke, Jr., et al. | Jun. 7, 1988 |
| 5,027,747 | Talley | Jul. 2, 1991 |

### OTHER REFERENCES AND PUBLICATIONS

Baldwin, Jack L., Lane D. Foil, J. A. Hogsett (2005), “Important Fly Pests of Louisiana Beef Cattle” Louisiana Cooperative Extension Service, Louisiana State University
Koehler, P. G., P. E. Kaufman (2006), “Stable Fly (Dog Fly) Control” IFAS Extension, University of Florida
Patrick, Carl D. (2005), “Self Treatment Devices for Horn Fly, Face Fly, and Lice Control on Beef Cattle” Beef Cattle Handbook, Texas A&M University
Tomberlin, Jeffery K. (2003), “Insect Control on Beef Cattle” Texas Cooperative Extension, Texas A&M University
Townsend, Lee (2007), “Horn Flies and Cattle” ENTFACT-509, University of Kentucky College of Agriculture
Whittier, W. Dee (2000), “Summer Fly Control on Cattle” Livestock Update, Virginia Cooperative Extension

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Flies and other insects are responsible for an annual loss amounting to hundreds of millions of dollars to the U.S. beef industry. The horn fly is one of the most prominant pests of cattle. Estimated losses of $800 million are attributed to this pest. About $60 million is spent annually on insecticides to control horn flies. Horn fly feeding on cattle results in blood loss and extreme annoyance, which disrupts normal behavior. This pest reduces milk production in cows which, in turn, decreases the weaning weight of calves. Horn flies also reduce weight gain in growing or yearling cattle. Stable flies are pests of cattle because of their blood-sucking activities. In addition to the blood loss, they annoy animals and interfere with their normal feeding behavior. All this results in weight loss or reduced weight gain and increased susceptibility to certain diseases. One research trial showed that 72% of the weight loss from this pest was caused by the bunching of animals and the resulting heat stress. The other 28% weight loss was attributed to actual stable fly feeding and the energy cattle used to fight flies (Baldwin, Jack L., Lane D. Foil, J. A. Hogsett). Furthermore, tear-soaked cheeks caused by face fly feeding activity is perceived by cattle buyers as a precursor to pinkeye, so animals with runny eyes are discounted if sold in that condition (Patrick, Carl D.).

These flies, specifically the horn fly and the stable fly, are known to not only feed on the animal's blood, but are considerably annoying to the livestock as well as people present. Thresholds accepted for these flies are 200 horn flies/cow and 4 stable flies/cow. Numbers greater than these will result in economic loss. Heart rates, respiratory rates, and urinary output increase when animals are exposed to 150-225 horn flies per head (Tomberlin, Jeffery K.). Individual flies pierce the skin with their short, tube-like mouthparts 20 to 30 times per day to ingest a small amount of blood (Townsend, Lee). An animal with 1000 flies may be bitten 20,000 to 30,000 times per day.

Studies done at Texas A&M University have documented average increases in weaned calf weights of 20-27 pounds when effective control of horn flies is implemented (Whittier, W. Dee). Stable flies can result in a loss of 10-20 percent in milk production and up to 40 pounds of beef gain eliminated per animal each year (Koehler, P. G., P. E. Kaufman).

In recent decades, the use of insecticide-impregnated ear tags has become popular. However, the low concentration levels associated with the use of insecticide-impregnated ear tags frequently leads to a population of flies that is resistant to that particular insecticide (Baldwin, Jack L., Lane D. Foil, J. A. Hogsett). The use of two fly tags (one in each ear) extends control by only 10-14 days in most areas (Whittier, W. Dee). By contrast, other methods, such as rubs or manual application, may allow for a concentration of sufficient strength to suppress resistant populations.

Efforts have been made to control horn fly larvae in manure with insecticides and growth regulators that are fed or actually administered to cattle. In general, the performance of ‘feed-throughs’ and boluses has been disappointing, probably because of the lack of adult fly reduction on the animals at the time of treatment and dispersal of adult flies from untreated herds in the same area (Baldwin, Jack L., Lane D. Foil, J. A. Hogsett). While horn flies generally stay on the cattle, they do leave to deposit eggs on manure. Horn flies can easily travel several miles.

Manual application of insecticide is very effective. Material can be poured or sprayed on each individual animal. In some cases, animals may be driven through a dip. Nevertheless, the use of manual application is frequently hindered or prevented by the high labor costs involved in applying the material and handling the cattle.

A number of self-treatment devices have been developed as a more efficient means of controlling flies. Labor is reduced and animals are not confined and stressed.

The dust bag is a widely available method used in the cattle industry. An insecticide dust is placed in a burlap sack or a commercially produced unit. When cattle rub the bag, the insecticide passes through holes in the bag and is deposited on the hide of the cattle. There are several problems associated with the use of the dust bag. By design, the dust bag is somewhat limited in addressing cattle of various heights. Furthermore, moisture can cause the dust to solidify and dramatically reduce the application rate.

Another popular self-treatment device is the cattle rub. The simplest rub consists of a rope with some type of absorbent material attached. The absorbent material is saturated with an insecticide dilution using mineral oil or diesel fuel (although diesel fuel irritates cattle skin and evaporates more quickly than mineral oil) or a commercially available product. There are a number of problems associated with the simple cattle rub. All of the cattle will not share the same enthusiasm for using the cattle rub and like the dust bag, the cattle rub may not thoroughly address animals of various heights. Larger animals may tear the rope rub down. In practice, all animals should receive adequate treatment.

However, with no provisions for forced use, consistently good horn fly and/or louse control cannot be assured. Older animals tend to use free-choice back rubbers or dust bags more frequently than do stockers and yearling heifers. Therefore, forced use is even more important to achieve satisfactory fly and louse control on young stock (Patrick, Carl D.). Furthermore, young cattle are much more susceptible to pinkeye and interference with growth (Whittier, W. Dee). It is clear that all devices which employ a voluntary or free-choice approach are going to be compromised in their effectiveness by a lack of uniform behavior on the part of the cattle.

Therefore, what is needed is an apparatus for the passive application of liquid pesticides to all cattle within the herd. The installation of the device should be configured in a manner such that all cattle are compelled to walk under the unit. There have been quite a number of inventions to address this need. Some of them use wicks or ropes.

U.S. Pat. No. 4,748,939 describes a device for applying pesticide to livestock which includes a vertical cylindrical reservoir and a wick positioning assembly. The device has dozens of parts with increased manufacturing cost and the wicking action may be hindered in a rainy climate. Furthermore, the device does not appear to be designed for specific use in an alley way to require the use by all cattle.

U.S. Pat. No. 1,129,977 describes a device for applying pesticide to livestock which includes a horizontal tubular hollow body with a plurality of threaded apertures. The vertical ropes are compressed in the apertures to hold them in place. There are several problems with this design. The compression of the rope will likely interfere with the flow of the insecticide and the compression may still not be sufficient to prevent large animals from removing the rope. The many threaded apertures add to the expense of manufacturing and present a maintenance obstacle should the threads become damaged.

U.S. Pat. No. 3,116,717 describes a device for applying pesticide to livestock which includes a large heavy horizontal absorbent member to which are attached a plurality of heavy vertical absorbent members. The absorbent members are very complex with various layers. The vertical absorbent members are joined to the horizontal absorbent member with bolts and brackets. The unit would be very expensive to manufacture, difficult to repair, and may have difficulty supporting its own weight.

U.S. Pat. No. 4,324,202 describes a livestock feeder which incorporates a plurality of wicks to apply insecticide to the face of livestock. While this is beneficial for certain types of flies, these feeder devices will not cover the entire length of the animal.

U.S. Pat. No. 5,027,747 describes a device for applying pesticide to livestock which again includes a horizontal reservoir for containing the liquid, means for mounting the reservoir above an animal pathway, a plurality of flexible wicks depending from the reservoir having proximal ends communicating with the interior of the reservoir so that liquid in the reservoir communicates with and moistens the wicks and distal ends adapted for extending into the animal pathway whereby an animal passing through the pathway contacts the moistened wicks and the wicks apply the liquid to the animal, and a flexible shield depending from the reservoir and adjacent to the wicks on one side so that when an animal passes through the pathway in one direction the flexible shield is positioned between the animal and the wicks to shield the animal from the wicks, but when the animal passes through the pathway in the opposite direction the animal contacts the wicks and is treated with the liquid. This device uses complex extrusions to hold specially designed vertical shields. The wicks are held by a linear cut in the PVC reservoir. The use of plastic for the main body seems questionable in the presence of large animals. The unit would be difficult to repair. Furthermore, the one direction shield could restrict the application of material and certainly add to manufacturing expense.

U.S. Pat. No. 2,998,803 describes a device for applying pesticide to livestock using sheets of absorbent material suspended from a large cylindrical reservoir. The construction of the device requires dozens of specialized parts.

In addition to regular wick type applicators, brushes and mops have been used. U.S. Pat. No. 4,324,202 describes a device for applying pesticide to livestock using mops and a spring tensioning unit to provide some variation for height. Again, the manufacture of the unit would be expensive, given the parts that are involved. Furthermore, the spring tensioning unit may not provide for sufficient variation in height.

U.S. Pat. No. 4,324,202 describes a device for applying pesticide to livestock using rotating discs supported by two cables extending from the ground to the top of a post. Again, the device has dozens of parts and cattle use it on a voluntary basis.

U.S. Pat. No. 2,581,028 describes a device for applying pesticide to livestock using an internal chain drive which is operated by the rubbing action of the cattle. Again, the device has dozens of complex parts and cattle use it on a voluntary basis.

A useful device must be effective, practical, and durable. Installation and maintenance should be fast and simple. Price and manufacturing must be reasonable.

### BRIEF SUMMARY OF THE INVENTION

The principal object of the present invention is to provide an effective, practical, and durable device for the passive application of liquid pesticides to cattle. Other objects of the present invention are a device that is fast and simple to install and maintain. Furthermore, the manufacturing of the device must be simple to allow a reasonable price for the unit.

A device is described for the passive application of liquid pesticides to cattle which utilizes a heavy structural steel channel for the main body and reservoir of the unit. The materials are extremely durable, relatively inexpensive, and manufacturing materials are readily available. The structural steel channel is mounted horizontally with a length of heavy structural steel angle welded and braced in a perpendicular manner to each end of the steel channel. The two steel angles serve as mounting brackets as well as the ends of the reservoir. A series of holes are linearly aligned in the bottom of the steel channel. The holes are punched. They are not threaded and do not incorporate any complex hardware. Solid core derby ropes may be fitted through each hole with each length of rope being looped through each pair of holes. A metal sleeve is crimped at half the length of each rope to prevent its removal through either hole. The crimp provides substantial strength and does not interfere with the flow of the liquid. A quantity of liquid pesticide is poured into the steel channel to be absorbed by the ropes, which extend below the steel channel. The liquid is transferred to the coat of livestock as contact is made with the ropes. Four lags bolts are used to secure the device by way of two heavy integral mounting brackets, between two corner posts or other suitable locations. Alternately, the device could also be suspended from chains. To insure the use of the apparatus by each animal, the apparatus may be mounted in a gate, fence opening, or alley, where cattle regularly pass to obtain water, shade, minerals, or food.

Horizontal reservoirs in different forms and materials have been included repeatedly in previous art. However, distinct from previous art, the present invention features the use of a structural steel channel for the body and reservoir of the device. The construction of the device is extremely simple and strong, using low cost materials and a very low number of parts. Furthermore, although ropes and wicks have been used repeatedly in previous, the present invention, using loops and crimped metal sleeves, secures the position of the rope in a manner which is novel to previous methods, does not interfere with the flow of the liquid, provides for excellent strength, and has a very low manufacturing cost. This device is useful, practical, effective, and extremely durable. It is simple in construction, installation, and maintenance.

In field tests conducted during the month of June in North Florida, cattle were trained for one day by allowing them to pass through the opening to reach a shaded area with no ropes installed. These cattle had not received any fly treatment for several months. The population of flies on each animal was extremely high. On the morning of day two, ropes were installed and insecticide was poured into the steel channel. A significant reduction in flies was observed later that afternoon. Within 48 hours of the introduction of the insecticide, the number of flies had been easily reduced to an acceptable level.

### BRIEF DESCRIPTION OF THE SEVERAL VIEWS OF THE DRAWING

FIG. 1 is a perspective view of the device mounted on two wood corner posts.

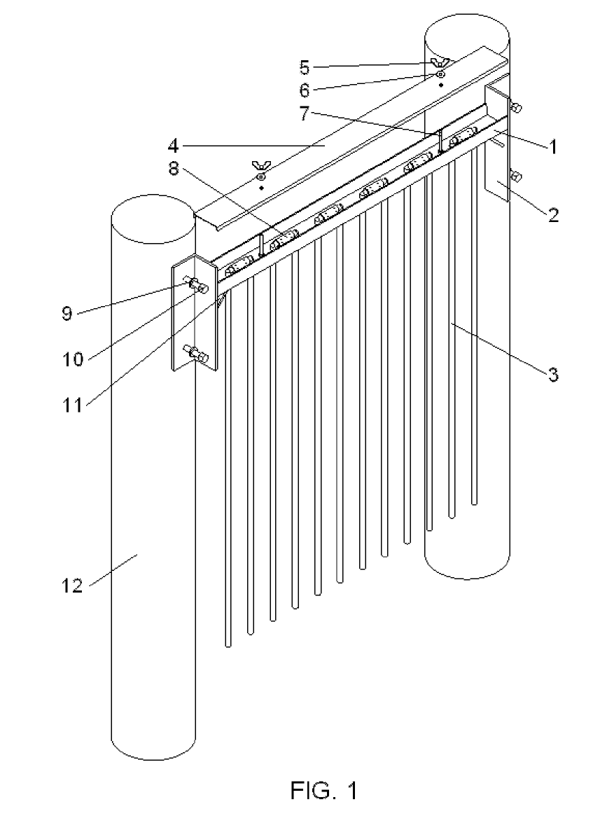

FIG. 2 is a front view of the device mounted on two wood corner posts of FIG. 1.

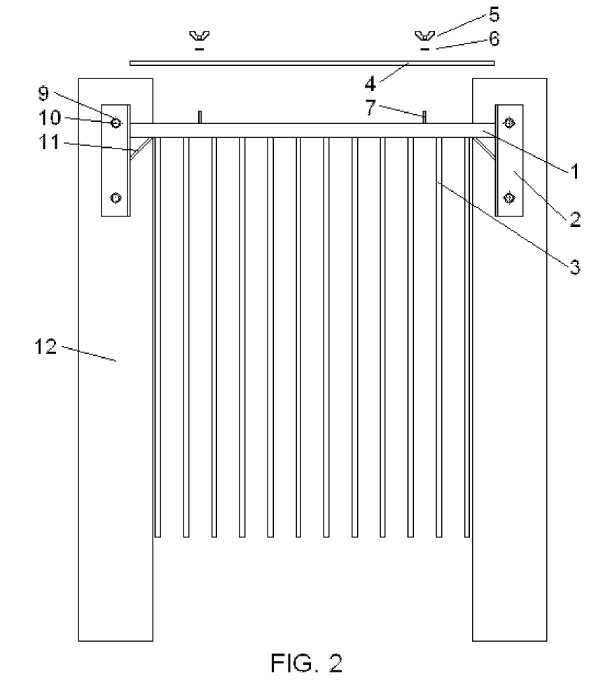

### DETAILED DESCRIPTION OF THE INVENTION

The horizontal frame 1 of the device can be made from a length of structural steel channel with an even number of linearly aligned holes punched along the center line in the bottom of the channel. Two lengths of steel heavy structural steel angle 2 are welded in a perpendicular manner to each end of the steel channel. Corner bracing 11 may be used to further strengthen the intersection of the steel channel 1 and steel angle 2. Metal sleeves 8 are crimped at half the length of each rope loop 3 to prevent their removal by livestock. Solid core derby rope may be used. The steel channel 1, which serves as a reservoir for the liquid insecticide, is covered by a lid 4. The lid 4 can be secured by two washers 6, two wing nuts 5, and two bolts 7 which are welded to the bottom of the steel channel 1. Four lags bolts 10 and four washers 9 may be used to secure the device between two corner posts 12 or other suitable locations. Alternately, the device could also be suspended from chains. The lid 4 is temporarily removed and a quantity of liquid pesticide is poured into the reservoir 1. Then, cattle are permitted to walk through the curtain of derby rope allowing the liquid to be transferred to their coat.

What is claimed is:

1. An apparatus for the passive application of liquid pesticides to cattle: utilizing a heavy steel channel for strength and simplicity in construction, extending horizontally to carry liquid pesticide to numerous linearly aligned holes, using rope loops passing through the holes to become saturated with the liquid that is poured into the channel, and transferring the liquid to the coat of livestock as contact is made with the ropes.

2. The apparatus for the passive application of liquid pesticides to cattle, as claimed in claim 1, an improvement comprising: crimped metal sleeves to secure the position of the rope loops which transfer the liquid to the coat of the livestock.

3. The apparatus for the passive application of liquid pesticides to cattle, as claimed in claim 1, an improvement comprising: a substantial structural frame and heavy integral mounting system well suited to the stress of large animals. livestock as contact is made with the ropes.
